(19) United States
(12) Patent Application Publication
(10) Pub. No.: US 2026/0197817 A1
(43) Pub. Date: Jul. 9, 2026

(54) SYSTEMS AND METHODS FOR SUBNETWORKING USING MANAGEMENT NODE USER EQUIPMENT

(71) Applicant: APPLE INC., Cupertino, CA (US)

(72) Inventors: Christian Hofmann, Munich (DE); Dimitrios Alanis, Munich (DE); Said Medjkouh, San Diego, CA (US); Panagiotis Botsinis, Munich (DE); Tarik Tabet, San Diego, CA (US); Alperen Gundogan, Munich (DE); Sameh M. Eldessoki, Munich (DE)

(21) Appl. No.: 19/418,544

(22) Filed: Dec. 12, 2025

Related U.S. Application Data
(60) Provisional application No. 63/742,197, filed on Jan. 6, 2025.

(51) Int. Cl. H04W 72/121; H04L 5/00; H04W 72/044; H04W 72/231; H04W 80/02

(52) U.S. Cl. CPC H04W 72/121; H04L 5/0051; H04W 72/044; H04W 72/231; H04W 80/02

(57) ABSTRACT

Systems and methods for subnetworking using management node user equipment (MN UE) are disclosed herein. The MN UE receives, from a base station, a configuration message defining an exclusive resource pool (ERP) that is exclusively for use by a subnetwork of UEs managed by the MN UE and one or more shared resource pools (SRPs) of a wireless communication system in which the base station operates; receives, from the base station, a first SRP grant for a first activation of a first SRP of the one or more SRPs for the subnetwork of UEs; and sends, to the subnetwork of UEs, after receiving the first SRP grant, a first control channel indication in the ERP that schedules a first subnetwork internal traffic of the subnetwork of UEs to use the first SRP. Related base station behaviors (including operations in cases for multiple subnetworks/MN UEs) are also disclosed.

### TECHNICAL FIELD

This application relates generally to wireless communication systems, including wireless communication systems that use subnetworks of user equipments (UEs).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for the use of SL mode 1, as may be implemented by some wireless communication systems.

FIG. 2 illustrates a diagram for the use of SL mode 2, as may be implemented by some wireless communication systems.

FIG. 3 illustrates a diagram of an SL BWP, as may be configured for use by/within a wireless communication system.

FIG. 4 illustrates a diagram for using a subnetwork of UEs, according to embodiments discussed herein.

FIG. 5 illustrates a diagram of an SN BWP as may be configured for use by/within a wireless communication system, according to embodiments discussed herein.

FIG. 6 illustrates a flow diagram for a grant of an SRP to a subnetwork, and a renewal of that grant, according to embodiments herein.

FIG. 7A and FIG. 7B together illustrate a flow diagram for a grant of an SRP to a first subnetwork, and then a grant of that same SRP to a second subnetwork, according to embodiments herein.

FIG. 8 illustrates a diagram of a wireless communication system that uses a subnetwork of UEs, according to embodiments discussed herein.

FIG. 9 illustrates a diagram for the allocation/use of granted resources in a subnetwork of UEs over time, according to embodiments discussed herein.

FIG. 10 illustrates a flow diagram for communications between an MN UE and a base station corresponding to granting of resources to a subnetwork managed by the MN UE, according to embodiments discussed herein.

FIG. 11 illustrates a method of an MN UE, according to embodiments discussed herein.

FIG. 12 illustrates a method of a base station, according to embodiments discussed herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

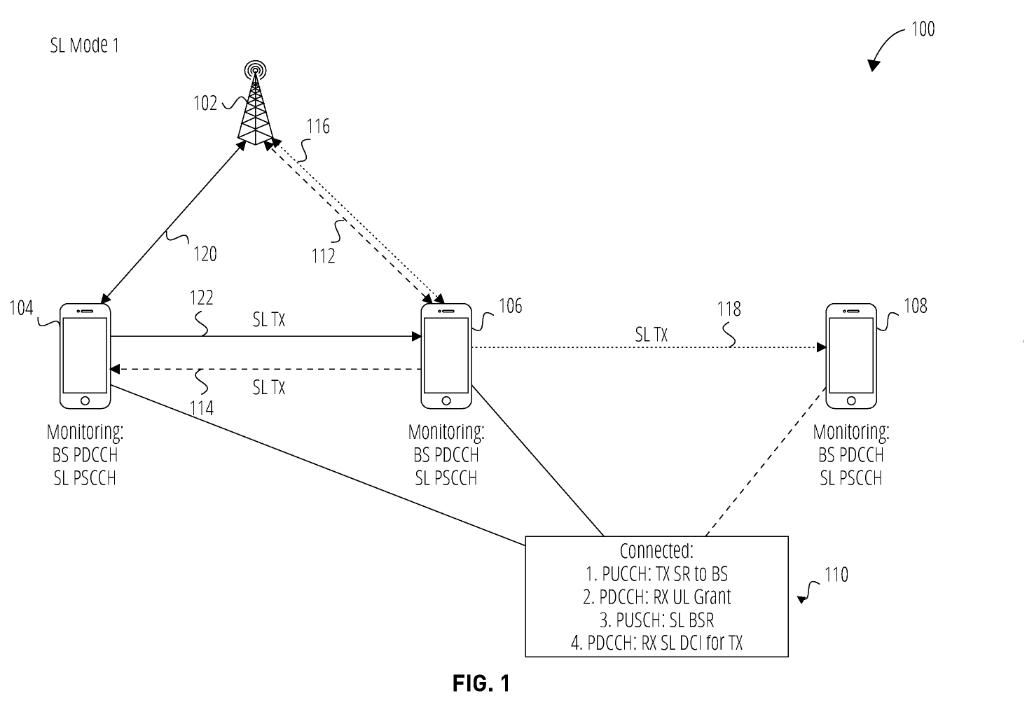

FIG. 1 illustrates a diagram 100 for the use of sidelink (SL) mode 1, as may be implemented by some wireless communication systems. SL mode 1 assumes a case of UE interaction with a base station. For example, under SL mode 1, UEs that engage in SL communications monitor physical downlink control channels (PDCCHs) from the base station, indicate SL buffer status reports (BSRs) to the base station, and/or receive SL scheduling (e.g., for performing SL communications in a transmit (Tx) direction) from the base station. Under SL mode 1, the base station may be responsible for coordinating the scheduling of SL resources of an SL resource pool that are used by the UEs to perform sidelink operations (SL Tx and/or SL Rx).

FIG. 1 illustrates a case where, for example, a base station 102 is in a connected mode 110 (e.g., a radio resource control (RRC) connected mode) with at least each of a first UE 104 and a second UE 106. Note that the base station 102 may or may not also be in the connected mode 110 with the third UE 108, as illustrated. When the base station 102 is not in the connected mode 110 with the third UE 108, this corresponds to a partial coverage scenario, because the third UE 108 is still reachable via SL through the second UE 106, as will be described.

Various examples of functionalities for obtaining scheduling for SL transmissions at various UEs (e.g., the first UE 104 and/or the second UE 106) are now described. A first example corresponds to first signaling 112 between the second UE 106 and the base station 102 that is for purposes of scheduling a first SL transmission 114 from the second UE 106 to the first UE 104. The second UE 106 may transmit a scheduling request (SR) to the base station 102 in a physical uplink control channel (PUCCH). In reply, the second UE 106 receives an uplink (UL) grant from the base station 102 in a PDCCH. The second UE 106 then transmits, according to the UL grant, an SL BSR to the base station 102 using a PUSCH, where the SL BSR indicates that the second UE 106 has SL data for the first UE 104. In reply, the second UE 106 receives, in a PDCCH from the base station 102, a downlink control information (DCI) that schedules the second UE 106 to correspondingly perform the first SL transmission 114 to the first UE 104. As illustrated, the second UE 106 then carries out the first SL transmission 114 to the first UE 104 as scheduled.

A second example corresponds to second signaling 116 between the second UE 106 and the base station 102 that is for purposes of scheduling a second SL transmission 118 from the second UE 106 to the third UE 108. The second UE 106 may transmit an SR to the base station 102 in a PUCCH. In reply, the second UE 106 receives an UL grant from the base station 102 in a PDCCH. The second UE 106 then transmits, according to the UL grant, an SL BSR to the base station 102 using a PUSCH, where the SL BSR indicates that the second UE 106 has SL data for the third UE 108. In reply, the second UE 106 receives, in a PDCCH from the base station 102, a DCI that schedules the second UE 106 to correspondingly perform the second SL transmission 118 to the third UE 108. As illustrated, the second UE 106 then carries out the second SL transmission 118 to the third UE 108 as scheduled. Note that this procedure is the same even in cases where the third UE 108 is an out-of-coverage UE.

A third example corresponds to third signaling 120 between the first UE 104 and the base station 102 that is for purposes of scheduling a third SL transmission 122 from the first UE 104 to the second UE 106. The first UE 104 may transmit an SR to the base station 102 in a PUCCH. In reply, the first UE 104 receives an UL grant from the base station 102 in a PDCCH. The first UE 104 then transmits, according to the UL grant, an SL BSR to the base station 102 using a PUSCH, where the SL BSR indicates that the first UE 104 has SL data for the second UE 106. In reply, the first UE 104 receives, in a PDCCH from the base station 102, a DCI that schedules the first UE 104 to correspondingly perform the third SL transmission 122 to the second UE 106. As illustrated, the first UE 104 then carries out the third SL transmission 122 to the first UE 104 as scheduled. Note that in this case, the transmitting UE (the first UE 104) and the target receiving UE (the second UE 106) are swapped from the case of the first example.

Finally, as illustrated, under SL mode 1, it is understood that each of the first UE 104, the second UE 106, and the third UE 108 (when it is an in-coverage UE) are performing monitoring for any base station PDCCHs (BS PDCCHs) from the base station and any SL physical sidelink control channels (PSCCHs) (SL PSCCHs) from other UEs. Note that in an alternative case where the third UE 108 is an out-of-coverage UE, it may may perform cell search instead of monitoring for BS PDCCHs.

Several aspects of SL mode 1 are now discussed. SL mode 1 may be understood to correspond to/represent a relatively high power consumption mechanism for enabling SL communication. This is because, under SL mode 1, there are various messages transmitted to a base station by a UE and/or received from the base station by a UE. These messages correspond to relatively long-range communications (e.g., as compared to SL communications among the UEs themselves) and therefore use relatively more power.

Further, SL mode 1 may be understood to correspond to/represent a relatively high latency mechanism for SL communication. This is because, under SL mode 1, there are a relatively high number of steps in the overall procedure.

Still further, SL mode 1 may be understood to correspond to/represent a case that is not privacy preserving. This is because the base station is ultimately aware of which UEs are transmitting to/receiving from which other UEs, and the amount of local data that is being exchanged.

Still further, SL mode 1 may be understood to correspond to/represent a case that is relatively less flexible. This is because there is direct base station involvement in many steps of the procedure. This may limit, for example, the amount of customization possible to react to different use cases, such as use cases for changing a synchronization interval (e.g., changing a transmission interval for synchronization signal blocks (SSBs)), use cases for lower power technologies for synchronization (e.g., Bluetooth® (BT) synchronizations), and/or use cases involving specific procedures (e.g., service-specific SRs) among UEs.

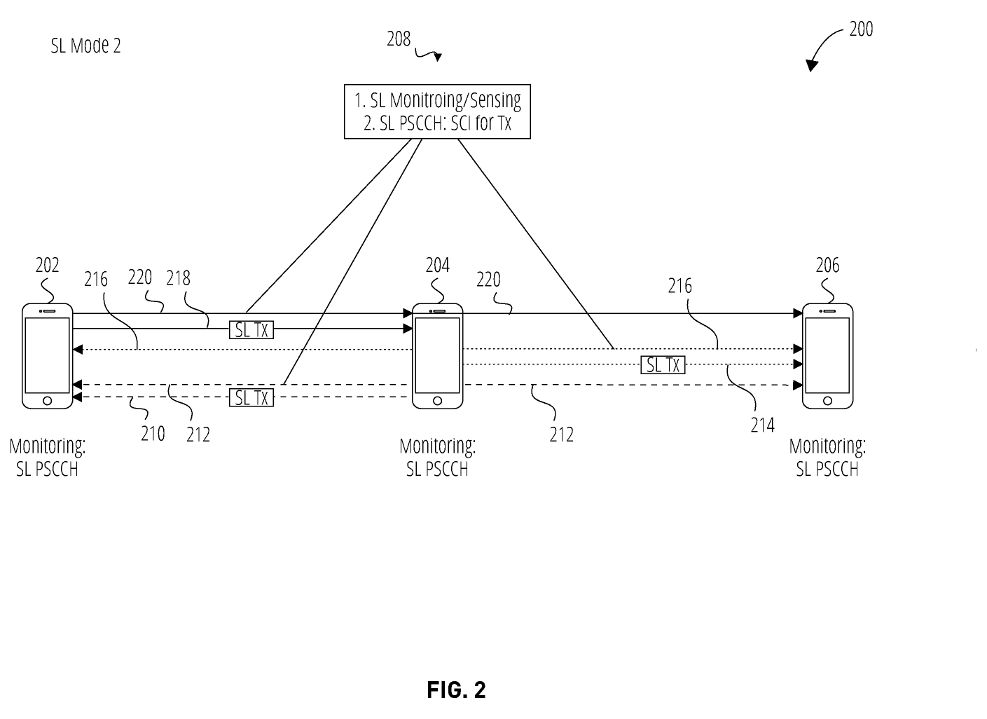

FIG. 2 illustrates a diagram 200 for the use of SL mode 2, as may be implemented by some wireless communication systems. As compared to SL mode 1, it may be understood that SL mode 2 removes various aspects of base station coordination for the allocation, scheduling, or use of resources of an SL resource pool. Instead, under SL mode 2, a UE may schedule resources of an SL resource pool for its own use. Accordingly, it will be understood that SL mode 2 may be useable in fully out-of-coverage usage scenarios.

Various implementations of SL mode 2 implement collision-based device-to-device (D2D) communication aspects. Such SL mode 2 cases may utilize channel sensing and/or resource reservation mechanisms.

FIG. 2 illustrates a case where, for example, a first UE 202, a second UE 204, and a third UE 206 operate according to SL mode 2. Note that each of the first UE 202, the second UE 204, and the third UE 206 is not in coverage by a RAN/base station.

Under SL mode 2, any UE (any of the first UE 202, the second UE 204, and/or the third UE 206) may perform one or more of the operations 208, as illustrated. Various examples for the use of the operations 208 are now described.

In a first example, the second UE 204 performs SL monitoring/sensing, as shown. Based on this SL monitoring/sensing, the second UE 204 identifies one or more SL resources of an SL resource pool that are not already reserved by another UE. The second UE 204 selects one or more resources from that free group of resources for its own use for a first SL transmission 210 and sends a first SL PSCCH 212 having control information (SCI) that indicates that the second UE 204 will use the selected resource(s) to perform the first SL transmission 210. This SCI informs the first UE 202 to expect the first SL transmission 210. The first SL PSCCH 212 also informs other UEs, such as the third UE 206, that the second UE 204 has reserved the resource(s) in question so that they do not use those resources, as shown. The second UE 204 then performs the first SL transmission 210 using the selected resource(s).

In a second example, the second UE 204 performs SL monitoring/sensing, as shown. Based on this SL monitoring/sensing, the second UE 204 identifies one or more SL resources of an SL resource pool that are not already reserved by another UE. The second UE 204 selects one or more resources from that free group of resources for its own use for a second SL transmission 214 and sends a second SL PSCCH 216 having SCI that indicates that the second UE 204 will use the selected resource(s) to perform the second SL transmission 214. This SCI informs the third UE 206 to expect the second SL transmission 214. The second SL PSCCH 216 also informs other UEs, such as the first UE 202, that the second UE 204 has reserved the resources in question so that they do not use those resources, as shown. The second UE 204 then performs the second SL transmission 214 using the selected resources.

In a third example, the first UE 202 performs SL monitoring/sensing, as shown. Based on this SL monitoring/sensing, the first UE 202 identifies one or more SL resources of an SL resource pool that are not already reserved by another UE. The first UE 202 selects one or more resources from that free group of resources for its own use for a third SL transmission 218 and sends a third SL PSCCH 220 having SCI that indicates that the first UE 202 will use the selected resource(s) to perform the third SL transmission 218. This SCI informs the second UE 204 to expect the third SL transmission 218. The third SL PSCCH 220 also informs other UEs, such as the third UE 206, that the first UE 202 has reserved the resources in question so that they do not use those resources, as shown. The first UE 202 then performs the third SL transmission 218 using the selected resources.

Finally, as illustrated, under SL mode 2, it is understood that each of the first UE 202, the second UE 204, and the third UE 206 are performing monitoring for any SL PSCCHs from other UEs. Each of the first UE 202, the second UE 204, and the third UE 206 may also be understood to be performing cell search operations as they are out of coverage of a base station.

Note that, as compared to communications of SL mode 1, communications of SL mode 2 may be understood to involve a higher degree of complexity at the UE and/or to be ultimately less reliable.

In various wireless communication systems, UEs can be configured simultaneously with up to three different bandwidth parts (BWPs): a downlink (DL) BWP used for Rx from a base station, an uplink (UL) BWP used for Tx to a base station, and an SL BWP used for Rx and/or Tx with other UE(s). Note that in some such mechanisms, the UL BWP and the SL BWP can overlap.

Validity of an UL BWP and/or a DL BWP is understood at the level of an individual UE that are in a connected mode (e.g., an RRC connected mode) with the network. Alternatively, the SL BWP is a common setting that every SL-participating UE possesses. Note that it is understood corresponding to such cases that the UL and DL BWPs are for Uu-Interface usage (communications between the network and the UE, a “Uu-usage”) while the SL BWP is for PC5-Interface-usage (D2D usage), an “SL-usage”.

A resource split between the Uu-usage and the SL-usage may be semi-static (e.g., as provided by an RRC configuration and/or according to a pre-configuration). Corresponding to such cases, SL resource pools (SL-RPs) may define the split (e.g. in an overlapping UL BWP/SL BWP case, an SL-RP may be understood to represent exclusively SL resources).

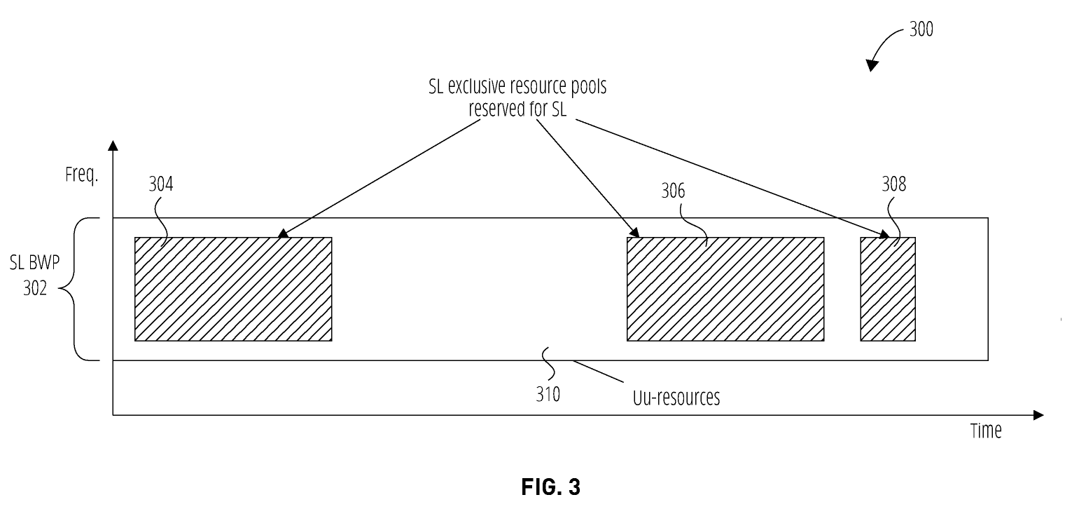

FIG. 3 illustrates a diagram 300 of an SL BWP 302 as may be configured for use by/within a wireless communication system. As shown, a first SL-RP 304, a second SL-RP 306, and a third SL-RP 308 may be defined within the SL BWP 302, while the remainder of the SL BWP 302 (the Uu resources 310) are resources associated with Uu-usage.

It has been identified that mechanisms for the configuration and use of these types of SL BWPs (as in the SL BWP 302 as just discussed) correspond to various inefficiencies. As just discussed, in such cases the network reserves SL resources for SL communication use across an entire set of UEs operating within the wireless communication system. Accordingly, the arrangement is not very flexible and/or dynamic, as in order to react to a changed SL resource allocation needs at any one UE, the network must reconfigure all the UEs within the system with a same changed SL configuration.

Embodiments herein accordingly discuss systems and methods for the configuration and use of subnetworks of UEs, for which relevant network topologies and granted resources for various communications (including SL-like/D2D-like communications) may be changed on a more dynamic, localized basis.

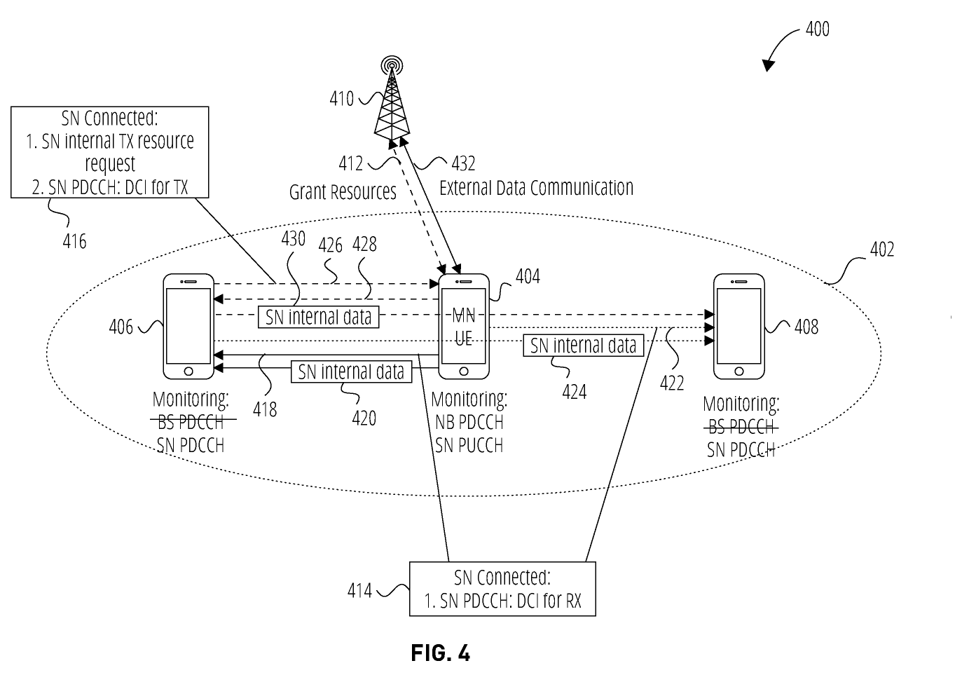

FIG. 4 illustrates a diagram 400 for using a subnetwork 402 of UEs, according to embodiments discussed herein. As illustrated, a subnetwork 402 of UEs includes a management node (MN) UE (MN UE) 404, the first managed UE 406 and the second managed UE 408.

Within the subnetwork 402, the MN UE 404 controls management aspects with respect to UEs in the subnetwork 402 (e.g., management aspects for the MN UE 404, the first managed UE 406, and/or the second managed UE 408). For example, the MN UE 404 may act as a scheduler for subnetwork internal traffic that occurs between UEs of the subnetwork 402.

According to a first aspect 414, an MN UE 404 schedules the receipt of subnetwork internal traffic at one or more subnetwork UEs. For example, according to a first aspect 414, the MN UE 404 may transmit a first subnetwork PDCCH (SN PDCCH) 418 to the first managed UE 406. The first SN PDCCH 418 may carry DCI that schedules the first managed UE 406 to receive first SN internal data 420 from the MN UE 404.

As another example, again according to the first aspect 414, the MN UE 404 may transmit a second SN PDCCH 422 to the second managed UE 408. The second SN PDCCH 422 may carry DCI that schedules the second managed UE 408 to receive second SN internal data 424 from the first managed UE 406

Further, according to a second aspect 416, the MN UE 404 schedules the transmission of subnetwork internal traffic from one or more subnetwork UEs. For example, the MN UE 404 may receive, from the first managed UE 406, a request 426 for a transmission resource for a subnetwork internal traffic from the first managed UE 406. The MN UE 404 may accordingly respond using third SN PDCCH 428 having a DCI that schedules the first managed UE 406 to perform a transmission of third SN internal data 430 to the second managed UE 408.

Using, for example, operations according to the first aspect 414 and the second aspect 416 along with managed UEs of the subnetwork (e.g., with the first managed UE 406 and/or the second managed UE 408), the MN UE 404 is enabled to schedule communications between UEs within the subnetwork without direct involvement of, for example, a base station of a RAN.

As illustrated, each of the first managed UE 406 and/or the second managed UE 408 may monitor for SN PDCCHs from the MN UE 404 for purposes of receiving scheduling for subnetwork internal traffic as described. Correspondingly, the MN UE 404 may monitor for any associated subnetwork PUCCHs sent by the first managed UE 406 and/or the second managed UE 408, as also illustrated.

The diagram 400 illustrates, in particular, aspects related to a network grant mechanism used within the subnetwork 402. As illustrated, it may be that the MN UE 404 performs base station-based PDCCH monitoring (BS PDCCH) for the subnetwork 402. Accordingly, the MN UE 404 can receive, from the base station 410, a grant 412 of resources from the network in such a BS PDCCH. Note that it may be that neither of the first managed UE 406 nor the second managed UE 408 is configured for BS PDCCH monitoring. Instead, they rely on the described SN PDCCH monitoring from the MN UE 404 for scheduling purposes.

Once the grant 412 from the network is received at the MN UE 404, the MN UE 404 may schedule any subnetwork internal traffic using the resources indicated within the grant 412 for the UEs of the subnetwork 402 through the use of SN PDCCHs (and corresponding/related signaling), as described herein.

It is observed that, assuming that a set of UEs are network subscribers, the network is to provide service to them according to their individual needs. Accordingly, in cases where the UEs are formed into subnetworks, with one UE of each subnetwork acting as an MN UE for that subnetwork, a base station can delegate dedicated resources towards the various subnetworks (by way of direct communication with their corresponding/representative MN UEs) in a coordinated/dynamic fashion. The network may allow/assume that each MN UE locally manages the granted resources.

Accordingly, each MN UE uses the granted resources to organize (e.g., schedule) subnetwork communication within its subnetwork of UEs. This organization occurs independently of any scheduling actions taken by any other MN UEs for any other subnetworks as may be present within the overall system. Note that the MN UE may be capable of calling for any communication type within its subnetwork of UEs, including D2D signaling, broadcast signaling, multicast signaling, and/or unicast signaling.

In some cases, a communication corresponding to the subnetwork may be purely local or internal to the subnetwork of UEs (subnetwork internal traffic). In other cases, a communication may need to occur between an entity that is external to the subnetwork of UEs and one of the UEs in the subnetwork. In such cases, an MN UE may act as a relay for such communication (note that FIG. 4 correspondingly illustrates an external data communication 432 that is relayed between the base station 410 and any UE of the subnetwork 402 through the MN UE 404). In the case of subnetwork internal traffic, no direct base station involvement/scheduling is used; instead, an MN UE more directly handles scheduling for such communications as appropriate (e.g., by scheduling for transmission and/or reception at one or more subnetwork UEs using SN PDCCHs, as described herein).

Note that within a subnetwork, a communication scheme can be optimized/customized for a particular use case. Examples could include adaptations that recognize that subnetwork internal traffic corresponds to shorter ranges, and thus use resources accordingly (e.g., based on assumptions of relatively lower latency and relatively less power consumption for the subnetwork internal traffic).

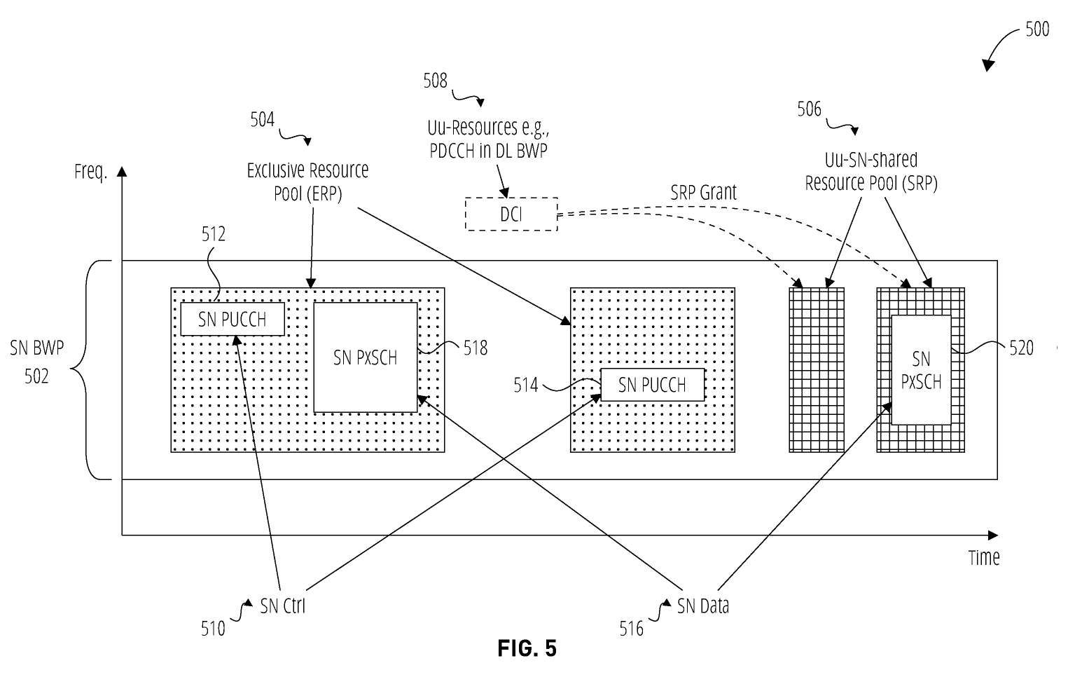

FIG. 5 illustrates a diagram 500 of a subnetwork BWP (SN BWP) 502, as may be configured for use by/within a wireless communication system, according to embodiments discussed herein. The diagram 500 illustrates the configuration/use of resources within the SN BWP 502 for one subnetwork of UEs.

Embodiments herein relate to the use of exclusive resource pools (ERPs) that are configured on a per-subnetwork basis. In other words, ERPs are exclusive per subnetwork of UEs (and are not global across all UEs engaged in different subnetworks). An ERP for a subnetwork may be configured to the MN UE of the subnetwork. The MN UE manages the access/use of resources within the ERP for its subnetwork. Further, as the ERP is exclusive to the given subnetwork, access within the ERP is not subject to potential collision due to use of those resources by other neighboring UEs (compare, for example, the case of SL mode 2, discussed elsewhere herein).

By way of example, FIG. 5 illustrates that an ERP 504 has been configured for the subnetwork of UEs within the SN BWP 502.

Embodiments herein relate to the use of shared resource pools (SRPs). SRPs are not necessarily exclusive to any particular subnetwork of UEs. Rather, a same SRP could be shared among/used by different subnetworks at the same time. Further, an SRP could be used for either/both Uu traffic managed by a base station and/or for subnetwork internal traffic managed by an MN UE (herein, this aspect may be referred to as a “Uu-SN-shared” aspect).

An SRP may be configured (e.g., to an MN UE) by a base station through RRC messaging.

By way of example, FIG. 5 illustrates that an SRP 506 has been configured/enabled within the SN BWP 502 for use by the subnetwork of UEs. Note that the SRP 506 may be used by other subnetwork(s) of UEs that have also been provided with the corresponding configuration and/or enabling signaling therefore.

Note that for the subnetwork of UEs, the ERP 504 is constantly active/available to the subnetwork to facilitate subnetwork communications. The ERP 504 may be used for, for example, subnetwork-related control channels and/or other channels benefiting from relatively increased robustness, like SN PDCCHs, SN PUCCHs, and/or or subnetwork discovery channels. Shared/data channels (e.g., SN physical uplink shared channels (PUSCHs) (SN PUSCHs) and/or SN physical downlink shared channels (PDSCHs) (SN PDSCHs)) may be used in ERPs in various embodiments.

On the other hand, SRPs (such as the SRP 506) are temporary in nature (e.g., they are enabled for a subnetwork on a limited/expiring basis). Further, such SRPs might not be exclusive to the subnetwork. The SRP 506 may be used for, for example, shared/data channels (e.g., SN PDSCHs and/or SN PUSCHs). As in some cases the SRP resources might be active for multiple subnetworks, there is potential for collision, which may be resolved through hybrid automatic repeat request (HARQ) functionality and/or via transmission repetition.

In various embodiments, a base station dynamically indicates, via a Uu interface communication, to a particular subnetwork (e.g., an MN UE of the subnetwork), whether a configured SRP can be used or not. For example, the base station may indicate, to the MN UE, one or more SRP identifiers (IDs) via DCI on PDCCH/physical broadcast control channel (PBCCH). As another example, the base station may make the indication of active SRP(s) for the subnetwork using a medium access control control element (MAC CE) that is sent to the MN UE.

By way of example, FIG. 5 illustrates the use of Uu resources 508 to indicate an SRP grant to the UE. In the particular example illustrated, the indication is made using a PDCCH in a DL BWP that includes a DCI that indicates an SRP grant for the SRP 506 to the MN UE. Alternative examples could instead use a MAC CE in Uu resources of the DL BWP that indicates the SRP grant for the SRP 506 to the MN UE.

The diagram 500 further illustrates the use of subnetwork control signaling 510 in the given arrangement. For example, the subnetwork control signaling 510 may be provided within the ERP 504. As illustrated, an example form of the subnetwork control signaling 510 may include SN PUCCH, such as the SN PUCCH 512 and/or the SN PUCCH 514.

The diagram 500 further illustrates the use of + 516 in the given arrangement. For example, the + 516 may be included in either the ERP 504 and/or the SRP 506. As illustrated, example form of the + 516 includes a subnetwork PxSCH (SN PxSCH) (e.g., an SN PUSCH or an SN PDSCH), such as the SN PxSCH 518 and/or the SN PxSCH 520.

An example case for the activation/deactivation of SRPs at a subnetworks of UEs is now provided. If a base station determines that a cell is loaded, the base station may indicate, to one or more MN UEs, that all configured SRPs are now to be used for Uu communication (i.e., SRP grant(s) to the MN UE(s) indicate that the SRPs are inactive for purposes of use by the subnetwork(s)). Assuming that the cell load later decreases, the base station may begin to indicate, to one or more of the MN UEs, which SRP(s) can be utilized for subnetwork traffic (i.e., SRP grant(s) to the MN UE(s) being to indicate that one or more SRPs are active for purposes of use by the subnetwork(s)).

Accordingly, a base station can grant, within a given SN BWP, SRPs to subnetworks in a dynamic fashion, allowing the base station to dynamically balance between the needs for subnetwork-external traffic (e.g., UL and/or DL via Uu) and the needs for subnetwork internal traffic (between UEs within the subnetwork(s)). Note that this is different than in SL-based cases (refer to FIG. 1 and FIG. 2 and related discussion herein), where the configured resource pools are SL-exclusive and thus use of the corresponding resources by the system is relatively more constrained.

Note that in various cases, BWP switching can be used by the base station in order to increase an overall bandwidth experienced by the subnetwork.

To facilitate the dynamic activation/deactivation of SRPs, a new UE capability for the MN UE may be defined corresponding to applicable timing requirements for the SRP activation/deactivation. For example, a T_SRP_delay capability may define an amount of time in advance by which an MN UE needs to know of an upcoming availability of an SRP for subnetwork internal traffic to be able to use those SRP resources for scheduling the subnetwork internal traffic. As another example, a T_SRP_active capability may define the length of time the granted SRP resources can be used by the subnetwork.

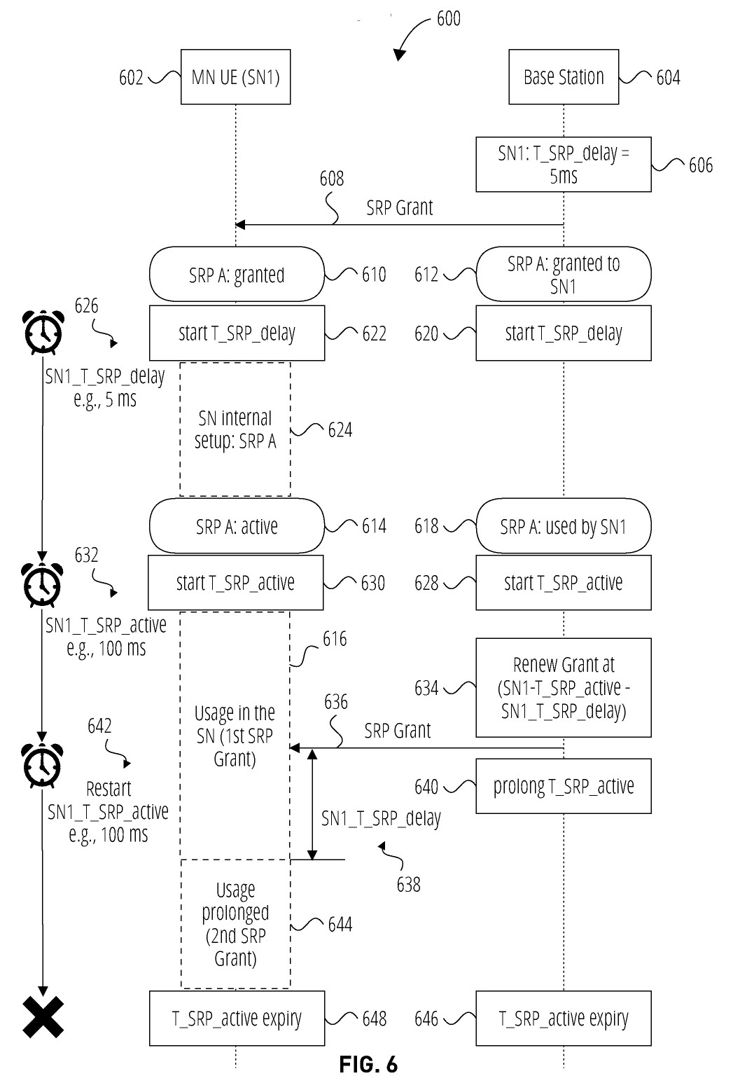

FIG. 6 illustrates a flow diagram 600 for a grant of an SRP to a subnetwork, and a renewal of that grant, according to embodiments herein. The flow diagram 600 illustrates communications between an MN UE 602 of a subnetwork (referred to as “SN1” in the flow diagram 600) and a base station 604 that grants the SRP (referred to as “SRP A” in the flow diagram 600) to the subnetwork.

Preliminarily, the flow diagram 600 illustrates that the base station 604 is aware that SN1 operates according to a T_SRP_delay capability 606 of five milliseconds (ms).

The base station 604 sends a first SRP grant 608 to the MN UE 602 to activate the use of SRP A for subnetwork internal traffic within SN1. Note that this first SRP grant 608 is sent prior to the desired activation time for SRP A at SN1 by at least the T_SRP_delay capability 606 for SN1, as just described. As a result of the first SRP grant 608, the MN UE 602 is informed 610 of the grant of SRP A to SN1. The base station 604 correspondingly treats 612 SRP A as granted to SN1 going forward.

After sending the first SRP grant 608, the base station 604 starts a first T_SRP_delay timer 620. Correspondingly, after receiving the first SRP grant 608, the MN UE 602 starts a second T_SRP_delay timer 622. Each of these timers tracks, for the respective host entity, a first T_SRP_delay period 626 after which SRP A will become active for use at SN1 for subnetwork internal traffic. As illustrated, the MN UE 602 uses first T_SRP_delay period 626 to perform any SN internal setup 624 for the use of SRP A in SN1.

At the end of the first T_SRP_delay period 626, the MN UE 602 begins 614 active use 616 of SRP A for subnetwork internal traffic in SN1, and the base station 604 correspondingly treats 618 SRP A as being under active use by SN1. In relation to the active use 616 of SRP A for subnetwork internal traffic in SN1, the base station 604 starts a first T_SRP_active timer 628. The MN UE 602 also starts a second T_SRP_active timer 630. Each of these timers tracks, for the respective host entity, a T_SRP_active period 632 during which SRP A is used 616 by SN1 for subnetwork internal traffic. The flow diagram 600 illustrates an example case where the first T_SRP_active period 736 is initially set to 100 ms.

As noted above, the flow diagram 600 corresponds to a case of a renewal of an SRP grant. Accordingly, prior to an expiration of the T_SRP_active period 632, the base station 604 determines 634 to renew the SRP grant. The renewal is effectuated/communicated by the sending of a second SRP grant 636 to the MN UE 602.

As illustrated, the base station 604 determines 634 to send the second SRP grant 636 at or before a time that corresponds to an expiration of the T_SRP_active period 632 minus the applicable T_SRP_delay capability 606. In this way, a second SRP grant 636 that is used to effectuate the renewal is sent with a timing that allows for a second T_SRP_delay period 638 for processing the second SRP grant 636 to expire at or prior to the expiration of the T_SRP_active period 632 corresponding to the first SRP grant 608, such that the use of SRP A at SN1 is uninterrupted.

Upon sending the second SRP grant 636, the base station 604 treats 640 the T_SRP_active period 632 as prolonged. Further, the MN UE 602 restarts 642 the second T_SRP_active timer 630 corresponding to the T_SRP_active period 632, such that the use 616 of SRP A by SN1 is prolonged 644. Accordingly, the use of SRP A in SN1 for subnetwork internal traffic continues beyond the initial 100 ms length initially set for the T_SRP_active period 632 in an uninterrupted fashion, as illustrated.

Eventually, the first T_SRP_active timer 628 at the base station 604 expires 646, at which point the base station 604 treats SRP A as not under active use by SN1 for subnetwork internal traffic going forward. Similarly, the second T_SRP_delay timer 622 at the MN UE 602 expires 648, at which point the MN UE 602 ceases the use 616 of SRP A for subnetwork internal traffic.

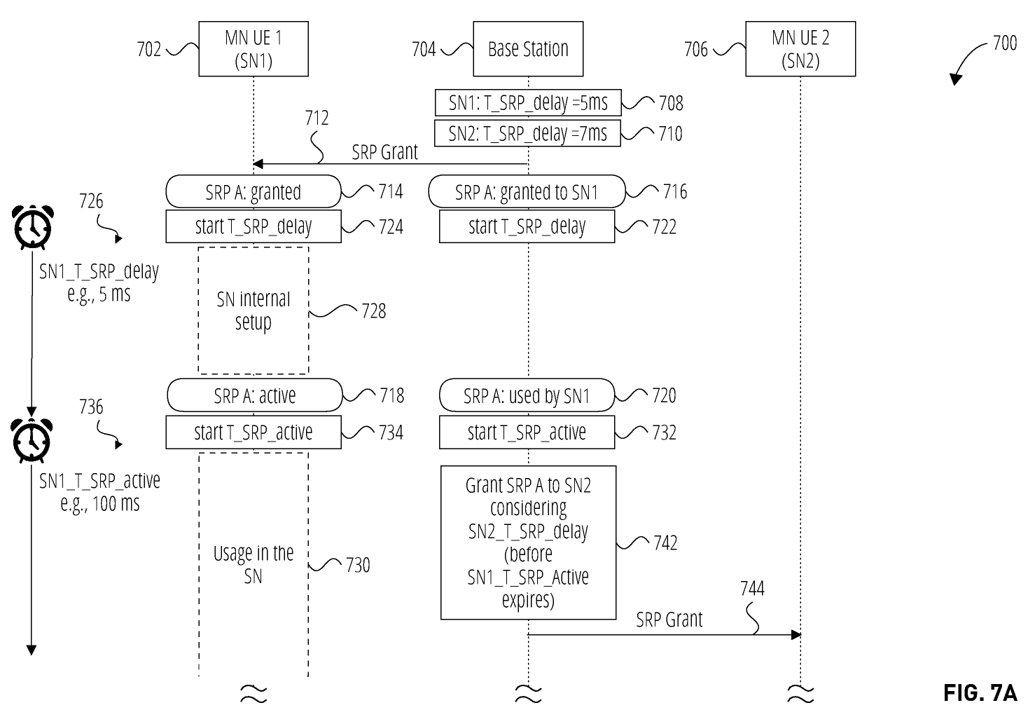

FIG. 7A and FIG. 7B together illustrate a flow diagram 700 for a grant of an SRP to a first subnetwork, and then a grant of that same SRP to a second subnetwork, according to embodiments herein. The flow diagram 700 illustrates communications between a first MN UE 702 of a first subnetwork (referred to as “SN1” in the diagram 700) and a base station 704 that grants the SRP (referred to as “SRP A” in the flow diagram 700) to the first subnetwork. The diagram 700 also illustrates communications between a second MN UE 706 of a second subnetwork (referred to as “SN2” in the diagram 700) and the base station 704 through which the base station 704 grants SRP A to the second subnetwork.

Preliminarily, the flow diagram 700 illustrates that the base station 704 is aware that SN operates according to a first T_SRP_delay capability 708 of five ms and that SN2 operates according to a second T_SRP_delay capability 710 capability of seven ms.

The base station 704 sends a first SRP grant 712 to the first MN UE 702 to activate the use of SRP A for subnetwork internal traffic within SN1. Note that this first SRP grant 712 is sent prior to the desired activation time for SRP A at SN1 by at least the first T_SRP_delay capability 708 for SN1 as just described. As a result of the first SRP grant 712, the first MN UE 702 is informed 714 of the grant of SRP A to SN1. The base station 704 correspondingly treats 716 SRP A as granted to SN1 going forward.

After sending the first SRP grant 712, the base station 704 starts a first T_SRP_delay timer 722. Correspondingly, after receiving the first SRP grant 712, the first MN UE 702 starts a second T_SRP_delay timer 724. Each of these timers tracks, for the respective host entity, a first T_SRP_delay period 726 after which SRP A will become active for use at SN1 for subnetwork internal traffic. As illustrated, the first MN UE 702 uses first T_SRP_delay period 726 to perform any SN internal setup 728 for the use of SRP A in SN1.

At the end of the first T_SRP_delay period 726, the first MN UE 702 begins 718 active use 730 of SRP A for subnetwork internal traffic in SN1, and the base station 704 correspondingly treats 720 SRP A as being under active use by SN1. In relation to the active use 730 of SRP A for subnetwork internal traffic in SN1, the base station 704 starts a first T_SRP_active timer 732. The first MN UE 702 also starts a second T_SRP_active timer 734. Each of these timers tracks, for the respective host entity, a first T_SRP_active period 736 during which SRP A is used 730 by SN1 for subnetwork internal traffic. The diagram 700 illustrates an example case where the first T_SRP_active period 736 is 100 ms.

At an expiration 738 of the second T_SRP_active timer 734 (corresponding to the end of the first T_SRP_active period 736), the first MN UE 702 determines 740 that SRP A is no longer allocated for SN1, and correspondingly ends the use 730 of SRP A in SN1.

As noted above, the diagram 700 corresponds to a case of grant of an SRP first to a first subnetwork and then, later, to a second subnetwork. As illustrated, prior to an expiration of thefirst T_SRP_active period 736 for corresponding to the use 730 of SN1 by first MN UE 702, the base station 704 determines 742 grant SRP A to SN2. The grant is effectuated/communicated by the sending of a second SRP grant 744 to the second MN UE 706 that manages SN2.

Note that this second SRP grant 744 is sent prior to the desired activation time for SRP A at SN2 by at least the second T_SRP_delay capability 710 for SN2. As a result of the second SRP grant 744, the second MN UE 706 is informed 748 of the grant of SRP A to SN2. The base station 704 correspondingly treats 750 SRP A as granted to SN2 going forward.

After sending the second SRP grant 744, the base station 704 starts a third T_SRP_delay timer 752. Correspondingly, after receiving the second SRP grant 744, the second MN UE 706 starts a fourth T_SRP_delay timer 754. Each of these timers tracks, for the respective host entity, a second T_SRP_delay period 746, after which SRP A will become active for use at SN2 for subnetwork internal traffic. As illustrated, the second MN UE 706 uses the second T_SRP_delay period 746 to perform any SN internal setup 756 for the use of SRP A in SN2.

At the end of the second T_SRP_delay period 746, the second MN UE 706 begins 758 active use 760 of SRP A for subnetwork internal traffic in SN2, and the base station 704 correspondingly treats 762 SRP A as being under active use by SN2.

Note that by sending the second SRP grant 744 for SRP A to the second MN UE 706 while the prior use 730 of SRP A by SN1 is still occurring and in view of the second T_SRP_delay capability 710 (as illustrated), the base station 704 configures SN2 to begin the use 760 of SRP A at the same time the use 730 of SRP A in SN1 ends, meaning that there is no “wasted” in-between period where SRP A is unallocated for use.

In relation to the active use 760 of SRP A for subnetwork internal traffic in SN2, the base station 704 starts a third T_SRP_active timer 764. The second MN UE 706 also starts a fourth T_SRP_active timer 766. Each of these timers tracks, for the respective host entity, a second T_SRP_active period 768 during which SRP A is used 760 by SN2 for subnetwork internal traffic. The diagram 700 illustrates an example case where the second T_SRP_active period 768 is 50 ms.

At an expiration 770 of the fourth T_SRP_active timer 766 (corresponding to the end of the second T_SRP_active period 768), the second MN UE 706 determines 772 that SRP A is no longer allocated for SN2, and correspondingly ends the use 760 of SRP A in SN2.

As is further illustrated, the base station 704 may also recognize an expiration 774 of the third T_SRP_active timer 764 that corresponds to the end of the second T_SRP_active period 768. In the case that the base station 704 has not sent any other SRP grant allocating the use of SRP A to any subnetwork at this time, the base station 704 correspondingly determines 776 that SRP A is free (inactive for/at any subnetwork) going forward.

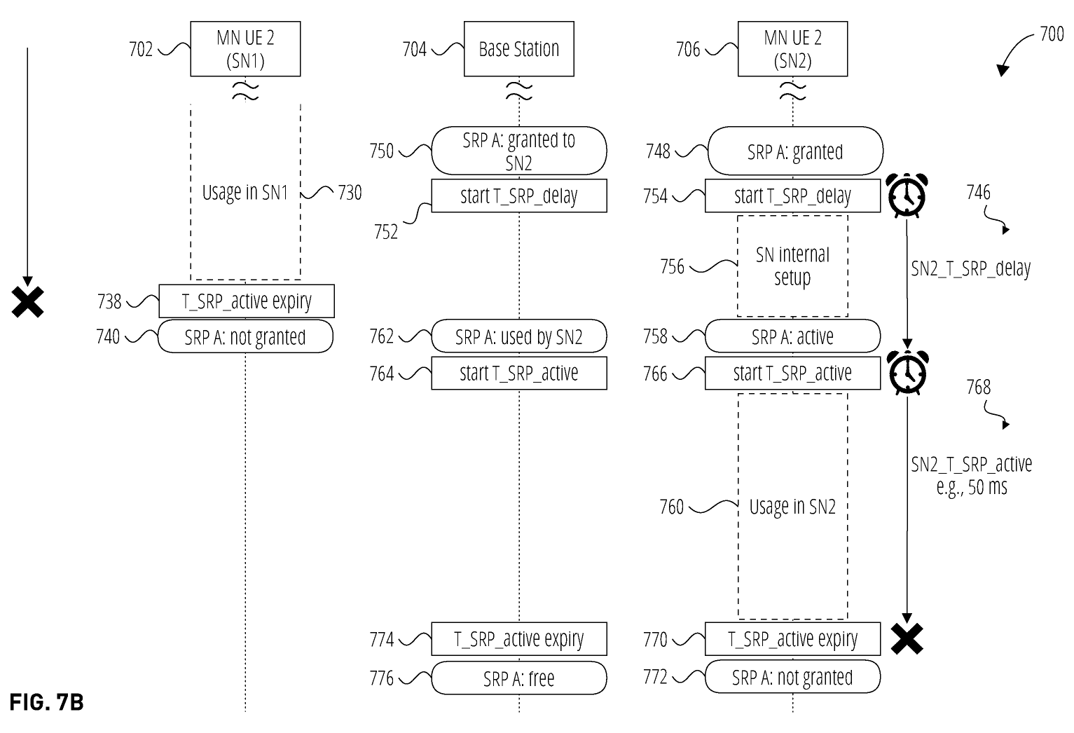

FIG. 8 illustrates a diagram 800 of a wireless communication system that uses a subnetwork 802 of UEs, according to embodiments discussed herein. The diagram 800 shows that the subnetwork 802 includes an MN UE 806 that communicates with a base station 804 of a RAN on a Uu link and a first managed UE 808, a second managed UE 810, and a third managed UE 812.

The diagram 800 further illustrates that the base station 804 also operates a Uu connection with each of a first non-subnetworked UE 814 and a second non-subnetworked UE 816.

Finally, note that the base station 804 is connected to the core network 818 for the overall wireless communication system.

The base station 804 may be configured to manage a fair balance between Uu traffic being sent to the first non-subnetworked UE 814 and/or the second non-subnetworked UE 816, subnetwork internal traffic of the subnetwork 802, and any relay traffic for the subnetwork that is transmitted between the MN UE 806 and the base station 804. Various metrics that may be used by the base station 804 for this purpose are now discussed.

In some cases, a base station uses a subnetwork size as a metric for granting resources to a subnetwork. In some cases, a subnetwork size metric may be understood in terms of a number of active UEs within the subnetwork. A base station may be aware of the UEs joining or leaving a subnetwork. Further, it is aware of the number of subscribers associated with those UEs and their individual traffic requirements. Accordingly, the base station can adapt the resources granted to the subnetwork accordingly.

For example, in the case of a subnetwork of best effort data UEs, only a relatively few SRP resources (a fewer number of SRP(s) and/or smaller SRP(s)) might be granted to the subnetwork for use. Alternatively, in the case of a subnetwork for internet protocol media subsystem (IMS) and/or voice over internet protocol (VoIP) UEs, relatively more SRP resources (a greater number of SRP(s) and/or larger SRP(s)) might be granted during periods when calls are active.

Note that an RRC status of a subnetwork UE may control whether that UE is counted towards the (active/applicable) subnetwork size that is reflected in the granted SRP resources as discussed. For example, a managed UE of the subnetwork that is in an RRC idle state may not be counted toward the subnetwork size for SRP resource granting purposes, while another managed UE of the subnetwork that is in an RRC connected state may be counted toward the subnetwork size for SRP resource granting purposes.

In some cases, a subnetwork size metric can be understood in terms of a dimension or geographic expansion/extent of the subnetwork (e.g., in terms of maximum communication distance). Then, if subnetwork internal traffic is to be very localized (e.g., where UEs of the subnetwork are separated by relatively shorter distances), the amount of SRP resources granted could be less compared to cases for larger distance subnetwork internal traffic cases (e.g., where UEs of the subnetwork are separated by relatively longer distances), as granted resources can be utilized more efficiently in the shorter distance case (e.g., relatively higher modulation schemes can be effectively used in such cases).

In some cases, a base station uses a subnetwork resource requirement report from a MN UE to activate or deactivate SRP resources at a corresponding subnetwork. For example, the MN UE may send the base station a traffic status report that is so used. The amount of traffic used within/by the subnetwork may be accumulated by the MN UE and then indicated as resource need to the base station. The base station can then activate or deactivate SRP(s) at the subnetwork represented by the MN UE accordingly. Note that this mechanism increases privacy for UEs in the subnetwork as compared to SL cases, in that the traffic status report is reported by the MN UE on an accumulated subnetwork basis and thus does not reveal particular information about specific UE to UE data communications within the subnetwork.

In some examples, a traffic status report may be given as a ratio between subnetwork external traffic (e.g., traffic that is relayed by the MN UE to/from the base station) and subnetwork internal traffic. Such a ratio may be understood to indicate to the base station how many resources are needed for subnetwork internal traffic. As the base station already understands the subnetwork external traffic use, it can use the indicated ratio to derive the resource requirement for the subnetwork internal traffic. For example, if the ratio indicated is 1.5, then the base station understands that the present resource requirement for the subnetwork internal traffic is 1.5 times the current amount of subnetwork external traffic.

In some cases, an MN UE may send the base station a resource demand corresponding to a local content distribution need. For example, an MN UE may report to the base station that same content (e.g., a live sports event, a same immersive environment, etc.) is to be relayed to different UEs within the subnetwork. In response, the base station can use its existing understanding of the Uu traffic demand/conditions of those UEs and their respective channel conditions to determine whether to use the MN UE as an intermediate hub for distributing that content to all of those UEs within the subnetwork (instead of the base station sending individual streams on Uu to each UE in the subnetwork)

Additional factors that may be used by the base station to determine subnetwork resource requirements are now discussed. It may be the case that there are different service levels associated with the operation of a subnetwork. For example, a subnetwork may be operated in a “control channel only” state, where licensed spectrum is used only for coordination, and where unlicensed spectrum is used for data transmission. Alternatively, a subnetwork may be operated in a “control and data” state, where using licensed spectrum is used for both coordination and data transmission. Alternatively, a subnetwork may be operated in a “data only” state, where licensed spectrum is used for particular data (e.g., latency critical data) unlicensed spectrum is used for other types of data. The base station may determine subnetwork resource requirement based on which of these states a subnetwork operates in in order to achieve the data transmission needs according to the operative state.

It may be the case that a base station determines subnetwork resource requirements based on a serving cell quality for the MN UE of the subnetwork. For example, when link between the MN UE and the base station is weak and the subnetwork is heavily using the relay from managed UE(s) to the base station through the MN UE, an amount of SRP resources to be granted to the subnetwork may be relatively lower. Further, such grants could be conditional, (for example, a particular SRP (SRP X) shall be indicated for use in the subnetwork only if a serving cell reference signal receive power (RSRP) reported to the base station by the MN UE meets a certain threshold Y. This allows the base station a mechanism to reuse the SRP X resources more effectively elsewhere (e.g., for Uu traffic or in another subnetwork) when the condition is not met.

It may be the case that a base station determines subnetwork resource requirements based on network conditions. For example, when a cell of the base station is loaded, the base station may prioritize the Uu-related communication by indicating SRP(s) as inactive to any subnetwork(s).

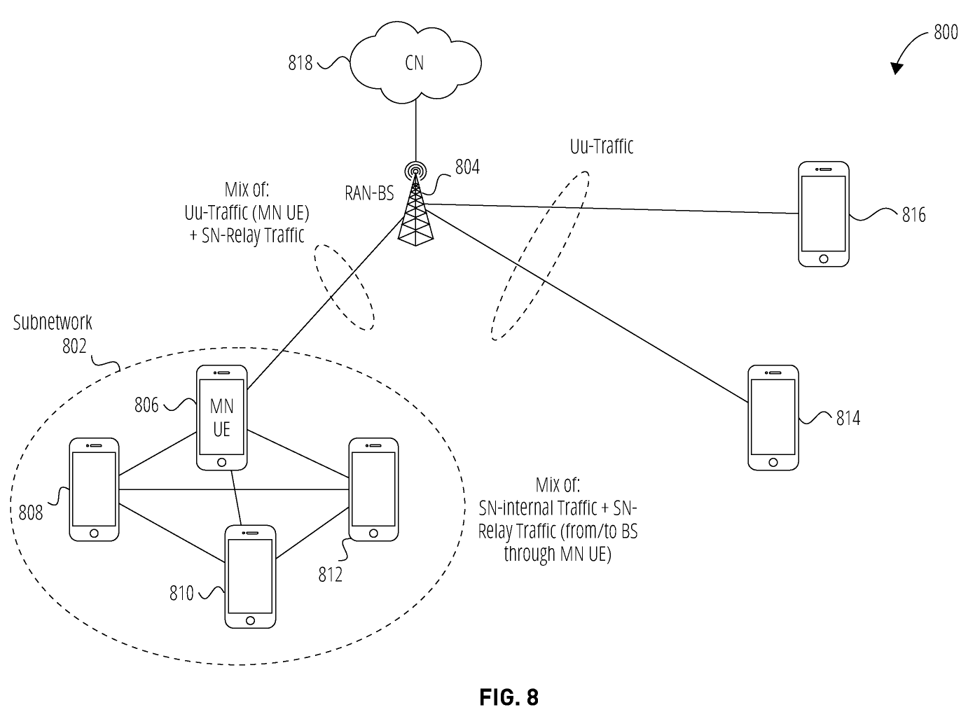

FIG. 9 illustrates a diagram 900 for the allocation/use of granted resources (ERP resources 902 and SRP resources 904) in a subnetwork of UEs over time, according to embodiments discussed herein. As illustrated, at a time of subnetwork formation 906, ERP resources 902 (e.g., one or more ERPs) are established for use by the subnetwork. These ERP resources 902 remain available for use in the subnetwork throughout the existence of the subnetwork.

The diagram 900 further illustrates that a first UE 908 then joins the subnetwork. The base station determines that the subnetwork can still operate sufficiently with only the ERP resources 902 even after the first UE 908 joins the subnetwork, and so no SRP resources are granted to the subnetwork at this time.

The diagram 900 further illustrates that a second UE 910 then joins the subnetwork. The base station determines that, due to the increased traffic demands for the subnetwork as a result of the addition of the second UE 910, the subnetwork needs more than just the ERP resources 902. Accordingly, as illustrated, the base station grants some SRP resources 904 (e.g., one or more SRP(s)) to the subnetwork for use going forward.

The diagram 900 further illustrates that a first MN UE report 912 is then sent to the base station by the MN UE of the subnetwork. The first MN UE report 912 indicates that the subnetwork needs access to many more resources than what are currently available. Accordingly, as illustrated, the base station grants additional SRP resources 904 (e.g., one or more additional SRP(s)) to the subnetwork for use going forward.

The diagram 900 further illustrates that a second MN UE report 914 is then sent to the base station by the MN UE of the subnetwork. The second MN UE report 914 indicates that the subnetwork needs access to fewer resources than what are currently available. Accordingly, as illustrated, the base station withdraws/does not renew the grant of some SRP resources (e.g., one or more SRP(s)) from the subnetwork going forward.

The diagram 900 further illustrates that a third MN UE report 916 is then sent to the base station by the MN UE of the subnetwork. The third MN UE report 916 indicates that the subnetwork needs access to more resources than what are currently available. Accordingly, as illustrated, the base station grants additional SRP resources 904 (e.g., one or more additional SRP(s)) to the subnetwork for use going forward.

The diagram 900 further illustrates that a fourth MN UE report 918 is then sent to the base station by the MN UE of the subnetwork. The third MN UE report 916 indicates that the subnetwork needs access to still more resources than what are currently available. Accordingly, as illustrated, the base station grants additional SRP resources 904 (e.g., one or more additional SRP(s)) to the subnetwork for use going forward.

The diagram 900 further illustrates that a network condition change 920 then occurs. As a result of the network condition change 920, it is expected that the base station may need more resources for Uu traffic than were previously in use. Accordingly, as illustrated, the base station withdraws/does not renew the grant of some SRP resources (e.g., one or more SRP(s)) from the subnetwork going forward (e.g., so the base station can use those resource for the Uu traffic instead).

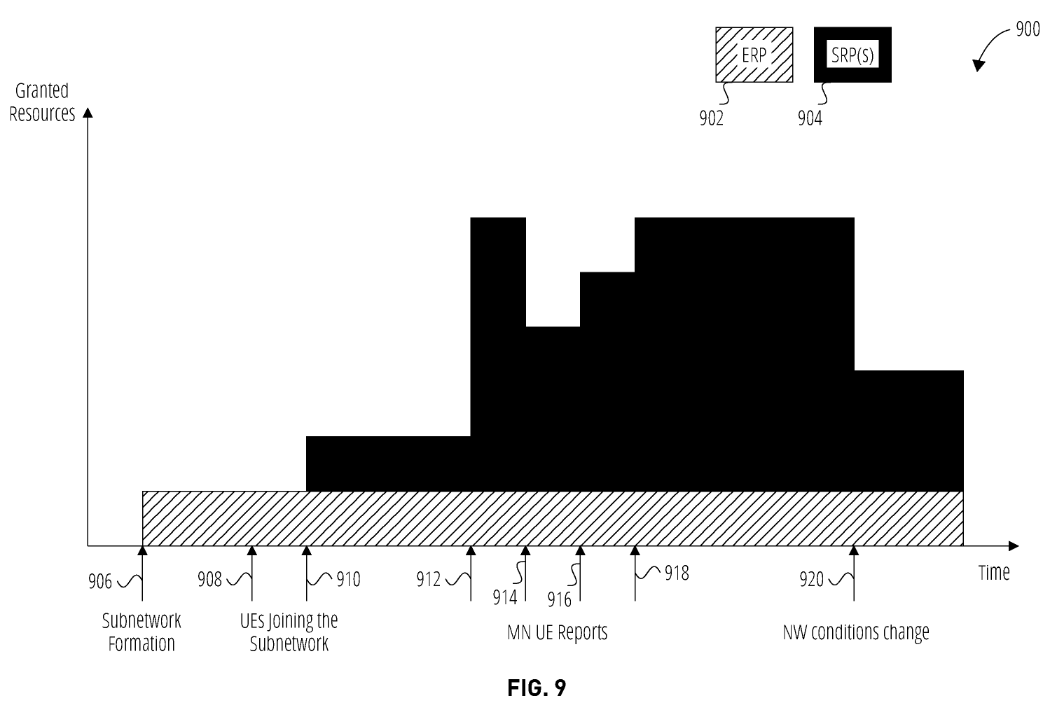

FIG. 10 illustrates a flow diagram 1000 for communications between an MN UE 1002 and a base station 1004 corresponding to granting of resources to a subnetwork managed by the MN UE 1002, according to embodiments discussed herein.

Preliminarily, the MN UE 1002 and the base station 1004 communicate to accomplish a subnetwork registration 1006 for the subnetwork. As a result of the subnetwork registration 1006, the base station 1004 is aware 1008 of the subnetwork and its members (the MN UE 1002 and any currently managed UEs), as illustrated.

Upon formation of the subnetwork, the base station 1004 configures a set of one or more ERPs, and potentially one or more SRPs, for the subnetwork. As shown, the base station 1004 sends the MN UE 1002 an RRC reconfiguration message 1010 that configures, to the MN UE 1002, one or more subnetwork BWP(s), a configuration for one or more ERPs for the subnetwork that is found within those BWP(s), and configuration(s) for one or more SRPs that may later be activated for use by the subnetwork(s) that is/are within those BWP(s).

Then, the base station 1004 evaluates 1012 the current resource situation for the subnetwork for purposes of determining whether to activate one or more SRPs within the subnetwork. In the example corresponding to the flow diagram 1000, it is assumed that, as a result of the evaluation 1012, the base station 1004 determines that an SRP is to be activated for the subnetwork.

Accordingly, as shown, the base station 1004 sends the MN UE 1002 a first SRP grant 1014. The first SRP grant 1014 includes an SRP ID that identifies one of the configured SRPs that is to be activated for use by the subnetwork. The first SRP grant 1014 further includes a validity time indicating an amount of time that the SRP is to be active for use at the subnetwork (e.g., a T_SRP_active value). Finally, as illustrated, the first SRP grant 1014 may further include one or more conditions for the SRP to be actively used in the event that the first SRP grant 1014 is intended to be conditional. For example, the first SRP grant 1014 may indicate a threshold for an RSRP that should be reported by the MN UE 1002 to the base station 1004 that should be met prior to the use of the SRP in the subnetwork.

As a response to the first SRP grant 1014, the MN UE 1002 starts a first validity timer 1016 (e.g., a T_SRP_active timer) to track an amount of time for which the SRP identified by the first SRP grant 1014 is to be used 1020 in the subnetwork. The first validity timer 1016 may be set for the amount of time equal to the validity time indicated in the first SRP grant 1014. As shown, a corresponding second validity timer 1018 may be started by the base station 1004 so that the base station can similarly track the amount of time that the SRP is under active use 1020 by the subnetwork.

Accordingly, as illustrated, the MN UE 1002/the subnetwork uses 1020 the SRP indicated in the SRP grant during the period corresponding to the running of the first validity timer 1016. As shown further, this use may be according to one or more conditions as may have been provided in the first SRP grant 1014.

From this point, the flow diagram 1000 illustrates various possible alternatives for subsequent operation. A first alternative 1022 corresponds to a case where there is a network or subnetwork change. For example, it may be determined 1024 that a UE has joined or left the subnetwork, that a UE of the subnetwork has changed to an RRC connected state or fallen to an RRC idle state, or that a loading of a cell operated by the base station 1004 has changed. Such a change may trigger the base station 1004 to (again) evaluate 1026 the current resource situation for the subnetwork for purposes of determining whether to activate one or more SRPs within the subnetwork.

In the example of the flow diagram 1000, the base station 1004 determines that, based on the change, SRP use at the subnetwork should be changed. Accordingly, the base station 1004 sends the MN UE 1002 a second SRP grant 1028. The second SRP grant 1028 may include any of an SRP ID that identifies one of the configured SRPs that is to be activated for use by the subnetwork, a validity time indicating an amount of time that that SRP is to be active for use at the subnetwork, and one or more conditions for that SRP to be actively used, as illustrated. In some cases, the second SRP grant 1028 indicates an additional SRP for use at the subnetwork. In some cases, the second SRP grant 1028 identifies the original SRP (of the first SRP grant 1014) and the thus the use of the original SRP is modified according to the new parameters in the first SRP grant 1014.

The first alternative 1022 may correspond to a case where a cell starts out in a loaded state, and where the base station 1004 has initially assigned all SRPs for Uu communication (i.e., any SRP grant indicates that the SRP is inactive for the subnetwork). At this stage, the subnetwork is limited to the use of its ERPs (which may carry, for example, subnetwork control channels and/or minimal subnetwork internal data traffic).

Then, if cell load later decreases or the subnetwork becomes larger (e.g., in geographic size and/or number of UEs), the base station 1004 performs the evaluation 1026 accordingly to indicate which SRPs can now be utilized for subnetwork traffic (i.e., the use of the second SRP grant 1028 indicates that the SRP is active for the subnetwork, as described).

A second alternative 1030 for continuing the flow diagram 1000 is now discussed. The second alternative 1030 may be understood to correspond to a case of a change or modification of the first SRP grant 1014 previously discussed.

As shown, the MN UE 1002 sends the utilization/metric report 1032 that indicates something about the state of SRP use at the subnetwork (e.g., that additional SRP resources would be useful at the subnetwork, or that too many SRP resources are presently allocated to the subnetwork).

The utilization/metric report 1032 may trigger the base station 1004 to (again) evaluate 1026 the current resource situation for the subnetwork for purposes of determining whether to modify the use of SRPs within the subnetwork.

As a result of the evaluation 1034, the base station 1004 determines to change the nature of SRP use at the subnetwork. Accordingly, the base station 1004 sends the MN UE 1002 a second SRP grant 1036. The second SRP grant 1036 may include any of an SRP ID that identifies the original SRP of the first SRP grant 1014, potentially a new validity time indicating a new amount of time that that SRP is to be active for use at the subnetwork, and potentially one or more conditions (e.g., new or modified) for that SRP to be actively used, as illustrated.

A third alternative 1038 for continuing the flow diagram 1000 is now discussed. The third alternative 1038 may be understood to correspond to a case of a change or modification of the first SRP grant 1014 previously discussed.

The third alternative 1038 corresponds to a case where the MN UE 1002 determines that the first validity timer 1016 has expired and/or that any condition identified in the first SRP grant 1014 for the use of the SRP is not met. In either case, the MN UE 1002 suspends 1040 its use of the SRP going forward, as shown. Note that in cases where the suspension 1040 is based on a failure to meet a condition, it is contemplated that the SRP may be used later if the condition is later met, while the first validity timer 1016 is still valid.

Embodiments corresponding to information that may be exchanged between a base station and a subnetwork are now discussed. In some cases, the network provides individual ERP and SRP configurations to each subnetwork. These configurations may include SRP IDs, time/frequency resources for the ERP(s)/SRP(s), periodicities for the for the ERP(s)/SRP(s), etc.

The network may provide an SRP grant for a subnetwork to an MN UE for that subnetwork. The SRP grant may include an SRP ID (e.g., that corresponds to that given in a prior configuration). The SRP grant may include a validity time for the SRP. Note that in some cases, a validity time may be understood as a duration for active use of the SRP in the subnetwork when the SRP is in an inactive state when the SRP grant is received, or as a duration for suspension of use of the SRP in the subnetwork when the SRP is already in an active state when the SRP grant is received. The SRP grant may include a validity condition. Examples of validity conditions include RSRP thresholds (e.g., thresholds for an RSRP reported by an MN UE to the base station) and location boundaries for which the SRP grant applies (e.g., geo location boundaries, cell ID-based boundaries, and/or tracking area (TA)-based boundaries).

The MN UE may provide a metric report to the network. In cases where the network can configure ERP/SRP resources to the subnetwork, it may use information from the subnetwork received in such metric reports to determine how many resources to grant to the SN in the form of ERP(s) and/or SRP(s). Examples of the contents of such metric reports include measurement reports corresponding to a link between the base station and the MN UE; a utilization report for presently granted resources (e.g., of currently granted ERP(s) and any SRP(s)); a ratio for subnetwork internal traffic versus subnetwork external traffic; a subnetwork UE activity ratio; an indication of a temporary resource need (e.g., in terms of bandwidth (BW), duration, etc.); a throughput demand corresponding to traffic/application classes, latency requirements/constraints, etc.; and/or an indication of a maximum distance of a managed UE from the MN UE and/or a pathloss for subnetwork internal communications.

Such metric reports may aid the network in estimating a resource need for subnetwork internal traffic, subnetwork external traffic being relayed through MN UE, and/or to coordinate SRP grants among different subnetworks.

Embodiments corresponding to inter-subnetwork interference management are now discussed. In some cases, a base station may use inter-subnetwork interference measurements. As the network ultimately owns the resources that are granted to the subnetworks, it is useful for the network to act as a coordinator for those grants in a manner that avoids inter-subnetwork interference, while also enabling frequency reuse for/across different subnetworks that are deployed in different areas of the cell (in other words, subnetwork-localized SRP reuse). Accordingly, the network may configure MN UEs to transmit inter-MN reference signals (e.g., in their ERPs, such that interference on the inter-MN reference signals due to transmissions from other entities of the system is not a factor). The network may configure other MN UEs to measure the transmitted inter-MN reference signals and report these measurements back to the network. This enables the network to coordinate resources among subnetworks/MN UEs. For example, using this information, the network can determine overlap/non-overlap of a same SRP across different subnetworks and accordingly manage SRP activity and configuration.

Embodiments corresponding to subnetwork interference measurements by non-subnetworked UEs are now discussed. In cases where a subnetwork BWP overlaps with a DL BWP, the base station may assign a non-subnetworked UE to perform measurement and corresponding reporting of signals specific to the subnetwork (e.g., an inter-MN reference signal) to allow the network to assess the impact of subnetwork local transmissions on those non-subnetworked UEs.

Various benefits achieved corresponding to the use of subnetworking embodiments discussed herein are now discussed. The embodiments herein may achieve relatively increased privacy protection as compared to network-centric solutions like integrated access and backhaul (IAB) and/or SL. This is because subnetwork internal communication is hidden from the network (e.g., as opposed to the IAB cases, where a network node has access to information about such inter-UE communications). Further, note that in SL cases (e.g., mode 1), the base station organizes D2D communication and therefore has particularized information about inter-UE communication.

Embodiments discussed herein enable more use-case-centric optimizations than are otherwise possible. Such optimizations may improve resource usage, latency and/or power use through the use of independent resource management within the subnetwork.

For example, it may be feasible to increase a synchronization interval (e.g., a synchronization signal block (SSB) transmission interval) used by the base station when using subnetworking embodiments. Any additional SSB needs beyond this reduced number of SSB transmissions by the base station by particular UE(s) can then be treated on a more localized subnetwork level corresponding to those particular UE(s).

As another example of optimization, broadcast and/or unicast usage can be effectively leveraged within a subnetwork. For example, for shared experience of users and/or multimodality, the subnetwork can implement different communication schemes within the granted resources with more flexibility than/independent from the network.

As another example of optimization, lower power technology for synchronization, random access, and/or SRs (e.g., via BT) may be implemented on a subnetwork basis. Further, custom procedures (e.g., service-specific SRs) as agreed within the subnetwork could be enabled.

As another example of optimization, privacy-preserving configured grant (CG) schemes can be agreed between the MN UE and the network.

The embodiments for subnetworking discussed herein may achieve more flexibility and/or adaptability as compared to SL cases, as the amount of resources reserved for subnetwork use is not fixed, and accordingly, the base station can more dynamically manage a balance between resources allocated for control by individual subnetworks versus Uu resources that remain under the control of the base station.

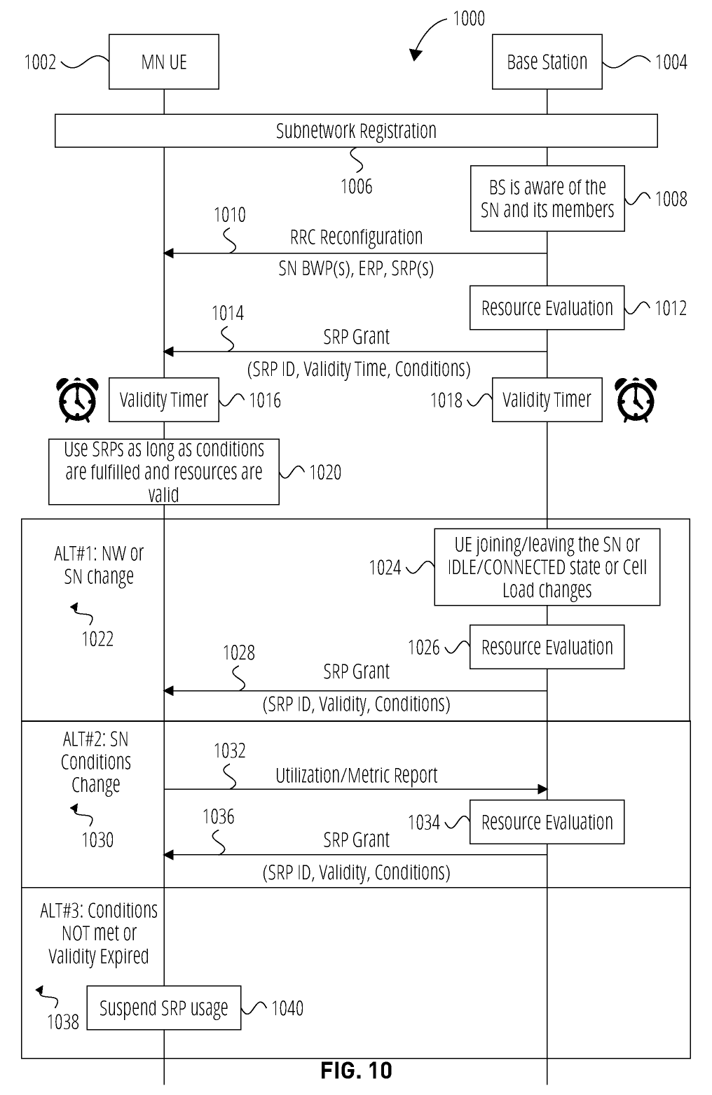

FIG. 11 illustrates a method 1100 of an MN UE, according to embodiments discussed herein. The method 1100 includes receiving 1102, from a base station, a configuration message defining an ERP that is exclusively for use by a subnetwork of UEs managed by the MN UE and one or more SRPs of a wireless communication system in which the base station operates. The method 1100 further includes receiving 1104, from the base station, a first SRP grant for a first activation of a first SRP of the one or more SRPs for the subnetwork of UEs. The method 1100 further includes sending 1106, to the subnetwork of UEs, after receiving the first SRP grant, a first control channel indication in the ERP that schedules a first subnetwork internal traffic of the subnetwork of UEs to use the first SRP.

In some embodiments of the method 1100, the first SRP grant further comprises a validity duration for the first activation of the first SRP for the subnetwork of UEs.

In some embodiments of the method 1100, the first SRP grant further comprises a condition for the first activation of the first SRP for the subnetwork of UEs. In some such embodiments, the condition comprises that the activation of the first SRP occurs when a serving cell RSRP measured by the MN UE meets a threshold. In some such embodiments, the condition comprises that the activation of the first SRP occurs when the MN UE is at an indicated location. In some such embodiments, the condition comprises that the activation of the first SRP occurs when the MN UE determines that one or more managed UEs of the subnetwork of UEs is within a specified area.

In some embodiments, the method 1100 further includes sending, to the base station, a traffic status report for the subnetwork of UEs, wherein the traffic status report indicates a ratio between a first amount of external traffic for the subnetwork of UEs and a second amount of internal traffic for the subnetwork of UEs, and wherein the first SRP grant is received from the base station in response to the traffic status report.

In some embodiments, the method 1100 further includes sending, to the base station, an indication that multiple managed UEs of the subnetwork of UEs are to receive first data, wherein the first SRP grant is received in response to the indication; receiving, from the base station, the first data; and providing the first data to a first UE of the multiple managed UEs and a second UE of the multiple managed UEs in the first subnetwork internal traffic.

In some embodiments, the method 1100 further includes sending, to the base station, an indication that a new managed UE has joined the subnetwork of UEs, wherein the first SRP grant is received from the base station in response to the indication.

In some embodiments, the method 1100 further includes sending, to the base station, an indication of a traffic type being used in the subnetwork of UEs, wherein the first SRP grant is received from the base station in response to the indication.

In some embodiments, the method 1100 further includes sending, to the base station, an indication that distances between UEs of the subnetwork of UEs has increased, wherein the first SRP grant is received from the base station in response to the indication.

In some embodiments, the method 1100 further includes receiving, from the base station, an instruction to transmit an inter-MN reference signal; and transmitting the inter-MN reference signal in the ERP.

In some embodiments, the method 1100, measuring an inter-MN reference signal transmitted by another MN UE to generate an inter-MN interference measurement; and sending, to the base station, the inter-MN interference measurement.

In some embodiments of the method 1100, the first SRP grant is further for a second activation of a second SRP of the one or more SRPs for the subnetwork of UEs.

In some embodiments, the method 1100 further includes receiving, from the base station, a second SRP grant for a second activation of a second SRP of the one or more SRPs for the subnetwork of UEs; and sending, after receiving the second SRP grant, a second control channel indication in the ERP that schedules a second subnetwork internal traffic of the subnetwork of UEs to use the second SRP.

In some embodiments, the method 1100 further includes determining that the first subnetwork internal communication experienced a collision within the first SRP; and sending, after determining that the first subnetwork internal communication experienced the collision, a retransmission of the first subnetwork internal communication.

In some embodiments of the method 1100, the first SRP is defined within frequency resources that are not licensed by the wireless communication system.

In some embodiments of the method 1100, the first SRP grant is received in a DCI.

In some embodiments of the method 1100, the first SRP grant is received in a MAC CE.

In some embodiments of the method 1100, the first subnetwork internal traffic is between a first managed UE of the subnetwork of UEs and a second managed UE of the subnetwork of UEs.

In some embodiments of the method 1100, the first subnetwork internal traffic is between the MN UE and a managed UE of the subnetwork of UEs.

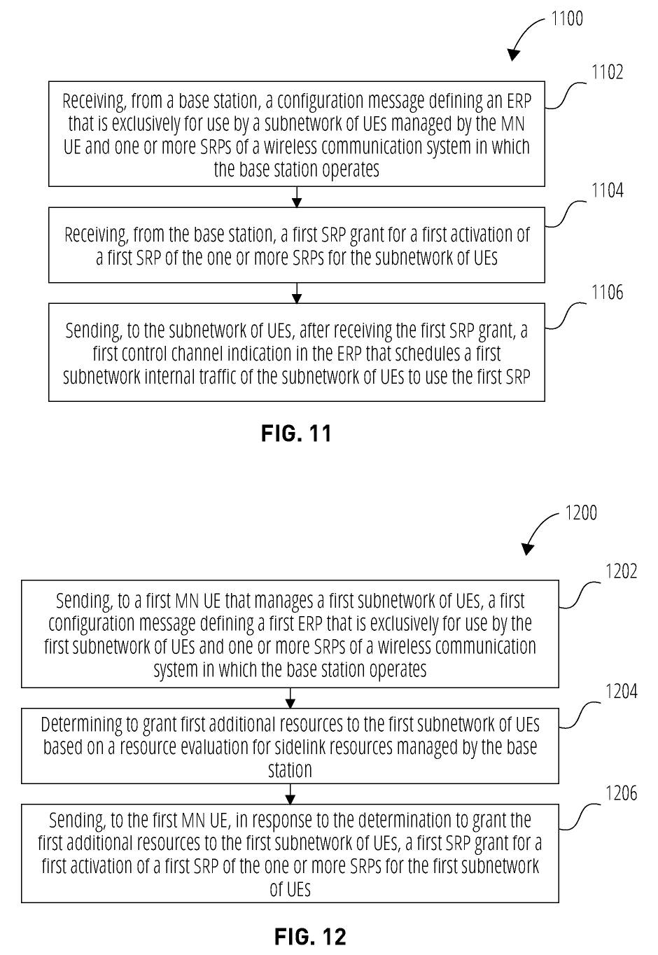

FIG. 12 illustrates a method 1200 of a base station, according to embodiments discussed herein. The method 1200 includes sending 1202, to a first MN UE that manages a first subnetwork of UEs, a first configuration message defining a first ERP that is exclusively for use by the first subnetwork of UEs and one or more SRPs of a wireless communication system in which the base station operates. The method 1200 further includes determining 1204 to grant first additional resources to the first subnetwork of UEs based on a resource evaluation for sidelink resources managed by the base station. The method 1200 further includes sending 1206, to the first MN UE, in response to the determination to grant the first additional resources to the first subnetwork of UEs, a first SRP grant for a first activation of a first SRP of the one or more SRPs for the first subnetwork of UEs.

In some embodiments of the method 1200, the first SRP grant further comprises a validity duration for the first activation of the first SRP for the subnetwork of UEs.

In some embodiments of the method 1200, the first SRP grant further comprises a condition for the first activation of the first SRP for the subnetwork of UEs. In some such embodiments, the condition comprises that the activation of the first SRP occurs when a serving cell RSRP measured by the first MN UE meets a threshold. In some such embodiments, the condition comprises that the activation of the first SRP occurs when the first MN UE is at an indicated location. In some such embodiments, the condition comprises that the activation of the first SRP occurs when the MN UE determines that one or more managed UEs of the subnetwork of UEs is within a specified area.

In some embodiments, the method 1200 further includes receiving, from the first MN UE, a traffic status report for the first subnetwork of UEs, wherein the traffic status report indicates a ratio between a first amount of external traffic for the first subnetwork of UEs and a second amount of internal traffic for the first subnetwork of UEs, and wherein the resource evaluation uses the traffic status report to make the determination to grant the first additional resources to the first subnetwork of UEs.

In some embodiments, the method 1200 further includes receiving, from the first MN UE, an indication that multiple managed UEs of the first subnetwork of UEs are to receive first data, wherein the resource evaluation uses the indication to make the determination to grant the first additional resources to the first subnetwork of UEs.

In some embodiments, the method 1200 further includes receiving, from the first MN UE, an indication that a new managed UE has joined the first subnetwork of UEs, wherein the resource evaluation uses the indication to make the determination to grant the first additional resources to the first subnetwork of UEs.

In some embodiments, the method 1200 further includes receiving, from the first MN UE, an indication of a traffic type being used in the first subnetwork of UEs, wherein the resource evaluation uses the indication to make the determination to grant the first additional resources to the first subnetwork of UEs.

In some embodiments, the method 1200 further includes receiving, from the first MN UE, an indication that distances between UEs of the subnetwork of UEs has increased, wherein the resource evaluation uses the indication to make the determination to grant the first additional resources to the first subnetwork of UEs.

In some embodiments, the method 1200 further includes sending, to the first MN UE, an instruction to transmit an inter-MN reference signal; and receiving, from a second MN UE, an inter-MN interference measurement of the inter-MN reference signal; wherein the resource evaluation uses the inter-MN interference measurement to make the determination to grant the first additional resources to the first subnetwork of UEs.

In some embodiments, the method 1200 further includes sending, to a second MN UE that manages a second subnetwork of UEs, a second configuration message defining a second ERP that is exclusively for use by the second subnetwork of UEs and the one or more SRPs of the wireless communication system; determining to grant second additional resources to the second subnetwork of UEs based on the resource evaluation; and sending, to the second MN UE, in response to the determination to grant the second additional resources to the second subnetwork of UEs, a second SRP grant for a second activation of the first SRP of the one or more SRPs for the second subnetwork of UEs. In some such embodiments, the second SRP grant is sent to the second MN UE prior to a deactivation of the first SRP at the first MN UE by an amount of time that is equal to an SRP grant setup delay for the second MN UE.

In some embodiments, the method 1200 further includes determining, after sending the first SRP grant, that a cell of the base station is heavily loaded; and sending, to the first MN UE, in response to the determination that the cell is heavily loaded, a withdrawal of the first SRP grant that deactivates the first SRP at the first MN UE.

In some embodiments of the method 1200, the first SRP is defined within frequency resources that are not licensed by the wireless communication system.

In some embodiments of the method 1200, the first SRP grant is received in a DCI.

In some embodiments of the method 1200, the first SRP grant is received in a MAC CE.

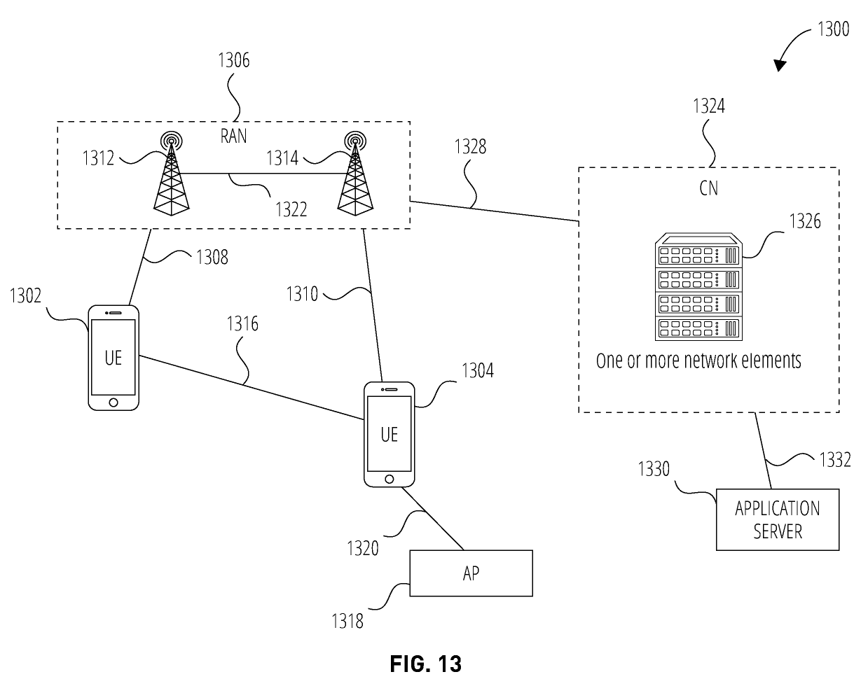

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi^{®} router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

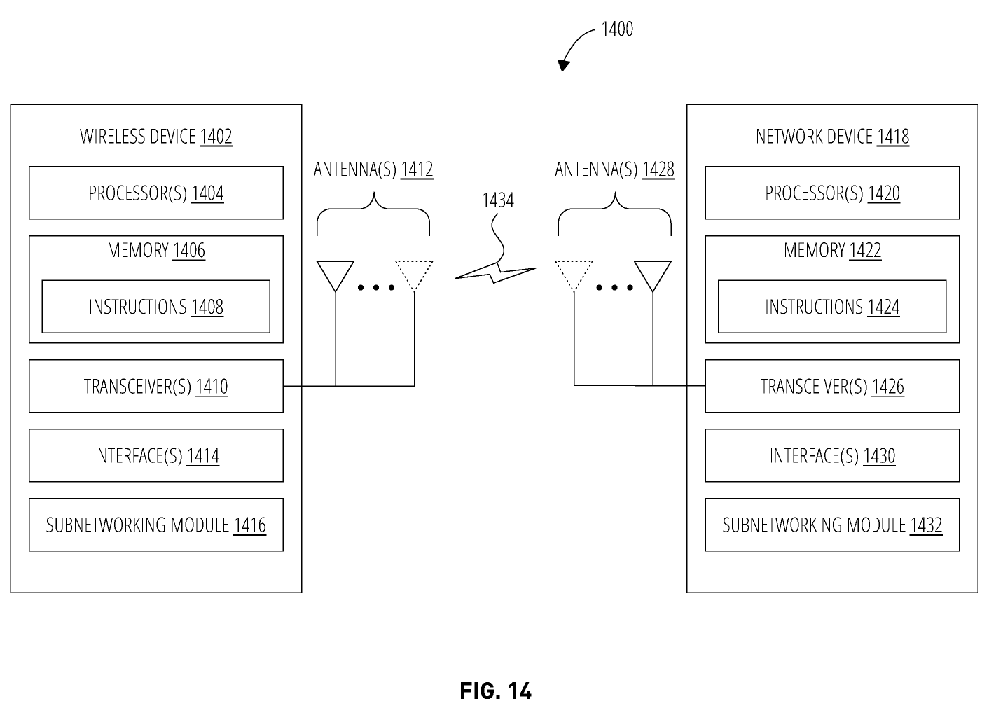

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter circuitry and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi^{®}, BT, and the like).

The wireless device 1402 may include a subnetworking module 1416. The subnetworking module 1416 may be implemented via hardware, software, or combinations thereof. For example, the subnetworking module 1416 may be implemented as a processor, circuit, and/or instructions 1408 stored in the memory 1406 and executed by the processor(s) 1404. In some examples, the subnetworking module 1416 may be integrated within the processor(s) 1404 and/or the transceiver(s) 1410. For example, the subnetworking module 1416 may be implemented by a combination of software components (e.g., executed by a DSP or a general processor) and hardware components (e.g., logic gates and circuitry) within the processor(s) 1404 or the transceiver(s) 1410.

The subnetworking module 1416 may be used for various aspects of the present disclosure, for example, aspects of FIG. 11. The subnetworking module 1416 may configure the wireless device 1402 to, for example, receive, from a base station, a configuration message defining an ERP that is exclusively for use by a subnetwork of UEs managed by the MN UE and one or more SRPs of a wireless communication system in which the base station operates; receive, from the base station, a first SRP grant for a first activation of a first SRP of the one or more SRPs for the subnetwork of UEs; and send, to the subnetwork of UEs, after receiving the first SRP grant, a first control channel indication in the ERP that schedules a first subnetwork internal traffic of the subnetwork of UEs to use the first SRP.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter circuitry and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a subnetworking module 1432. The subnetworking module 1432 may be implemented via hardware, software, or combinations thereof. For example, the subnetworking module 1432 may be implemented as a processor, circuit, and/or instructions 1424 stored in the memory 1422 and executed by the processor(s) 1420. In some examples, the subnetworking module 1432 may be integrated within the processor(s) 1420 and/or the transceiver(s) 1426. For example, the subnetworking module 1432 may be implemented by a combination of software components (e.g., executed by a DSP or a general processor) and hardware components (e.g., logic gates and circuitry) within the processor(s) 1420 or the transceiver(s) 1426.

The subnetworking module 1432 may be used for various aspects of the present disclosure, for example, aspects of FIG. 12. The subnetworking module 1432 may configure the network device 1418 to, for example, send, to an MN UE that manages a subnetwork of UEs, a configuration message defining an ERP that is exclusively for use by the subnetwork of UEs and one or more SRPs of a wireless communication system in which the network device 1418 operates; determine to grant additional resources to the subnetwork of UEs based on a resource evaluation for sidelink resources managed by the network device 1418; and send, to the MN UE, in response to the determination to grant the additional resources to the subnetwork of UEs, an SRP grant for an activation of a first SRP of the one or more SRPs for the subnetwork of UEs.

Embodiments contemplated herein include an apparatus comprising means to perform one or more elements of the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1402 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 1200. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 1200. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1418 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1420 of a network device 1418 that is a base station, as described herein). These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a management node (MN) user equipment (UE), comprising:
receiving, from a base station, a configuration message defining an exclusive resource pool (ERP) that is exclusively for use by a subnetwork of UEs managed by the MN UE and one or more shared resource pools (SRPs) of a wireless communication system in which the base station operates;
receiving, from the base station, a first SRP grant for a first activation of a first SRP of the one or more SRPs for the subnetwork of UEs; and
sending, to the subnetwork of UEs, after receiving the first SRP grant, a first control channel indication in the ERP that schedules a first subnetwork internal traffic of the subnetwork of UEs to use the first SRP.

2. The method of claim 1, wherein the first SRP grant further comprises a validity duration for the first activation of the first SRP for the subnetwork of UEs.

3. The method of claim 1, wherein the first SRP grant further comprises a condition for the first activation of the first SRP for the subnetwork of UEs.

4. The method of claim 3, wherein the condition comprises that the activation of the first SRP occurs when a serving cell RSRP measured by the MN UE meets a threshold.

5. The method of claim 3, wherein the condition comprises that the activation of the first SRP occurs when the MN UE is at an indicated location.

6. The method of claim 3, wherein the condition comprises that the activation of the first SRP occurs when the MN UE determines that one or more managed UEs of the subnetwork of UEs is within a specified area.

7. The method of claim 1, further comprising sending, to the base station, a traffic status report for the subnetwork of UEs, wherein the traffic status report indicates a ratio between a first amount of external traffic for the subnetwork of UEs and a second amount of internal traffic for the subnetwork of UEs, and wherein the first SRP grant is received from the base station in response to the traffic status report.

8. The method of claim 1, further comprising:
sending, to the base station, an indication that multiple managed UEs of the subnetwork of UEs are to receive first data, wherein the first SRP grant is received in response to the indication;
receiving, from the base station, the first data; and
providing the first data to a first UE of the multiple managed UEs and a second UE of the multiple managed UEs in the first subnetwork internal traffic.

9. The method of claim 1, further comprising sending, to the base station, an indication that a new managed UE has joined the subnetwork of UEs, wherein the first SRP grant is received from the base station in response to the indication.

10. The method of claim 1, further comprising sending, to the base station, an indication of a traffic type being used in the subnetwork of UEs, wherein the first SRP grant is received from the base station in response to the indication.

11. The method of claim 1, further comprising sending, to the base station, an indication that distances between UEs of the subnetwork of UEs has increased, wherein the first SRP grant is received from the base station in response to the indication.

12. The method of claim 1, further comprising:
receiving, from the base station, an instruction to transmit an inter-MN reference signal; and
transmitting the inter-MN reference signal in the ERP.

13. The method of claim 1, further comprising:
measuring an inter-MN reference signal transmitted by another MN UE to generate an inter-MN interference measurement; and
sending, to the base station, the inter-MN interference measurement.

14. The method of claim 1, wherein the first SRP grant is further for a second activation of a second SRP of the one or more SRPs for the subnetwork of UEs.

15. The method of claim 1, further comprising:
receiving, from the base station, a second SRP grant for a second activation of a second SRP of the one or more SRPs for the subnetwork of UEs; and
sending, after receiving the second SRP grant, a second control channel indication in the ERP that schedules a second subnetwork internal traffic of the subnetwork of UEs to use the second SRP.

16. The method of claim 1, further comprising:
determining that the first subnetwork internal communication experienced a collision within the first SRP; and
sending, after determining that the first subnetwork internal communication experienced the collision, a retransmission of the first subnetwork internal communication.

17. The method of claim 1, wherein the first SRP is defined within frequency resources that are not licensed by the wireless communication system.

18. The method of claim 1, wherein the first SRP grant is received in a downlink control information (DCI).

19. The method of claim 1, wherein the first SRP grant is received in a medium access control control element (MAC CE).

20. The method of claim 1, wherein the first subnetwork internal traffic is between a first managed UE of the subnetwork of UEs and a second managed UE of the subnetwork of UEs.
